(19) United States
(12) Patent Application Publication
(10) Pub. No.: US 2015/0030462 A1
(43) Pub. Date: Jan. 29, 2015

(54) WASHING WATER PUMP DEVICE AND CONTROL METHOD

(71) Applicant: Dr. Ing. h.c. F. Porsche Aktiengesellschaft, Stuttgart (DE)

(72) Inventor: Ekkehard Boekenkamp, Karlsruhe (DE)

(21) Appl. No.: 14/324,293

(22) Filed: Jul. 7, 2014

(30) Foreign Application Priority Data
Jul. 26, 2013 (DE) 102013107988.1

(51) Int. Cl. B60S 1/48

(52) U.S. Cl. CPC B60S 1/481
USPC 417/14

(57) ABSTRACT

A washing water pump device includes a washing water pump and a control unit configured to control operation of the washing water pump. The control unit is configured to receive and evaluate signals relating to a state of a vehicle and/or ambient conditions of the vehicle. The power (L) of the washing water pump is dynamically actuatable based on the received and evaluated signals.

### CROSS REFERENCE TO RELATED APPLICATIONS

Priority is claimed to German Patent Application No. DE 10 2013 107 988.1, filed on Jul. 26, 2013, the entire disclosure of which is hereby incorporated by reference herein.

### FIELD

The invention relates to a washing water pump device and a method for controlling a washing water pump.

### BACKGROUND

Washing water is used in motor vehicles to clean the front and rear windshields. For this purpose, the washing water is fed by means of a washing water pump and sprayed onto the front windshield or the rear windshield by means of at least one nozzle.

DE 10 2007 046 145 A1 discloses a windshield washing system having a pump for spraying washing water onto a windshield, wherein the pressure of the washing water spraying out of the spray nozzles is controlled as a function of the velocity of the vehicle.

DE 103 40 499 A1 discloses a method for operating a windshield cleaning system in which the triggering of an automatic spraying process, the injection quantity, the injection time and/or the injection period are implemented as a function of ambient parameters.

It has become apparent that the supply with washing water leaves a lot to be desired.

### SUMMARY

In an embodiment, the present invention provides a washing water pump device including a washing water pump and a control unit configured to control operation of the washing water pump. The control unit is configured to receive and evaluate signals relating to a state of a vehicle and/or ambient conditions of the vehicle. The power (L) of the washing water pump is dynamically actuatable based on the received and evaluated signals.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 shows a schematic view of a washing water pump device of a motor vehicle;

FIG. 2 shows a diagram; and

FIG. 3 shows a diagram.

### DETAILED DESCRIPTION

An aspect of the present invention provides a washing water pump device and a method for controlling the washing water pump which provide improved supply with washing water.

An exemplary embodiment of the invention relates to a washing water pump device having a washing water pump and a control unit for controlling the operation of the washing water pump, wherein signals relating to the state of the vehicle and/or its ambient conditions can be received and evaluated by means of the control unit, and the power of the washing water pump can be actuated dynamically on the basis of these signals. The power of the washing water pump can therefore be controlled with adaptation as a function of the state of the vehicle, such as, in particular, the vehicle velocity and/or ambient conditions, with the result that the power is adapted in accordance with demand and is actuated variably over time.

In this context it is particularly advantageous if the power of the washing water pump can be actuated by means of pulse width modulation (PWM). The power of the washing water pump can therefore be changed and actuated incrementally or continuously.

In this context it is particularly advantageous if the power of the washing water pump can be actuated as a function of the vehicle velocity, the outside temperature and/or the state of the roof by means of pulse width modulation (PWM). In this context, the power can be predefined as a function of the vehicle velocity, wherein influence can be applied as corrections on the basis of the outside temperature and/or the state of the roof of the vehicle. It is therefore possible to actuate a different power level of the water pump with the roof, sun roof or convertible top open than with the roof, sun roof or convertible top closed. The power can also be changed as a function of the outside temperature.

It is particularly advantageous if the power of the washing water pump can be actuated as a function of the vehicle velocity in PWM increments or by means of a continuous PWM value. The power can correspondingly be adapted as a function of the vehicle velocity, wherein this specific power can be changed or corrected by means of other parameters. It is therefore possible to determine the power L as a PWM value as L=Px where Px=a velocity-dependent value or a velocity-dependent function. It is therefore possible, for example, to actuate the value P1 from a velocity v=0 to v=v1, to actuate the value P2 from v=v1 to v=v2 and to actuate the value P3 from v=v2 to v=v3. Correspondingly, a value Px can be actuated for each interval where x=1, 2, . . . . Alternatively, the value of the power L can be determined as a function of the velocity v as L=L(v). In this context, the function can be continuous over the entire velocity range or can also be divided into various velocity intervals and be continuous in each interval.

It is also expedient if the velocity-dependent value of the PWM value can be changed as a function of the outside temperature. It is therefore possible to correct the value of the power as L=Px by means of a temperature-dependent additive term. In this context the following is possible: L=Px+Offset_Tx where Offset_Tx as a correction value in the temperature interval from Tx−1 to Tx where x=1, 2, . . . . The correction value Offset_Tx can assume positive or negative values here as a function of x.

It is also advantageous if the velocity-dependent value of the PWM value can be changed additively and/or multiplicatively as a function of the outside temperature. It is therefore possible to correct the value of the power as L=Px alternatively also by means of a temperature-dependent term which is multiplicative. In this context the following is possible: L=Px*Offset_Tx with Offset_Tx as a correction value in the temperature interval from Tx−1 to Tx for x=1, 2, . . . . The correction value Offset_Tx can assume positive or negative values here as a function of x.

Furthermore, it is advantageous if the velocity-dependent value of the PWM value can be changed as a function of the state of the roof It is therefore possible for the value of the power to be corrected as L=Px by an additive term which is dependent on the state of the roof In this context the following is possible: L=Px+Offset_Dx with Offset_Dx as a correction value in the interval from Dx−1 to Dx where x=1, 2, 3 etc. The correction value Offset_Dx can assume postive or negative values here as a function of x. It is therefore possible, for example, for a state of a closed roof, sun roof or convertible top to be considered as a state D1 and for a state of a partially or completely opened roof, sunroof or convertible top to be considered as a state D2. Alternatively, the state of a partially opened roof, sun roof or convertible top can also be subdivided more finely with the result that the state of opening can be defined, for example, in increments. It is therefore possible to specify the state of opening, for example, in 5%, 10% or 20% increments.

It is advantageous here if the velocity-dependent value of the PWM value can be changed additively and/or multiplicatively as a function of the state of the roof It is therefore possible that, in addition to the additive correction contribution above, said contribution is also multiplicative such as, for example, L=Px*Offset_Dx.

It is particularly preferred if the temperature-dependent correction is carried out jointly with the correction as a function of the state of the roof These corrections then bring about a change in the velocity-dependent value by means of a temperature-dependent contribution and a roof-dependent contribution which can each be additive and/or multiplicative.

The following is therefore possible, for example: L=Px+Offset_Tx+Offset_Dx. Alternatively the following is also possible: L=(Px*Offset_Tx)+Offset_Dx, or L=(Px*Offset_Dx)+Offset_Tx or L=Px*Offset_Tx*Offset_Dx.

By means of the correction a value for the power is determined which, owing to the various terms, could easily also have less than 0% or more than 100%. In this context it is expedient if the power of the washing water pump is limited with a minimum value of 0% and a maximum value of 100%. Certain values of less than 0% are therefore corrected to 0%, and certain values which are greater than 100% are corrected to 100%.

It is expedient here if in the case of an activation period t of the washing water pump which is longer than a predefinable time value, the power of the washing water pump can be actuated in a rising fashion. It is therefore possible, after the expiry of a predefinable time period t, to increase the power L of the washing water pump from a predefined value in, for example, a linear fashion or else incrementally up to a predefinable power or up to a maximum power.

It is also advantageous if the power of the washing water pump can be actuated in a rising fashion with at least one predefinable gradient. It is therefore possible when rising occurs for a selected gradient to be actuated or alternatively different gradients can also be actuated in different intervals.

An exemplary embodiment of the invention relates to a method for controlling a washing water pump having a control unit for controlling the operation of the washing water pump, wherein the control unit receives signals relating to the state of the vehicle and/or its ambient conditions and actuates the power of the washing water pump dynamically on the basis of these signals.

It is expedient here if the power of the pump is actuated by means of pulse width modulation (PWM).

It is also advantageous if the power of the pump is controlled as a function of the vehicle velocity, the outside temperature and/or the state of the roof by means of pulse width modulation (PWM).

It is also advantageous if the power of the washing water pump is actuated as a function of the vehicle velocity in PWM increments or by means of a continuous PWM value.

It is particularly advantageous if the velocity-dependent value of the PWM value is changed as a function of the outside temperature.

It is also advantageous if the velocity-dependent value of the PWM value is changed additively and/or multiplicatively as a function of the outside temperature.

It is advantageous here if the velocity-dependent value of the PWM value is changed as a function of the state of the roof.

It is also advantageous if the velocity-dependent value of the PWM value is changed additively and/or multiplicatively as a function of the state of the roof

It is also expedient if the change in the velocity-dependent value is additive and/or multiplicative by virtue of a temperature-dependent contribution and a roof-dependent contribution.

It is also advantageous if the power of the washing water pump is limited with a minimum value of 0% and a maximum value of 100%.

According to the invention it is advantageous if in the case of an activation period which is longer than a predefinable value the power of the washing water pump is actuated in a rising fashion.

According to the invention it is advantageous if the power of the washing water pump is actuated in a rising fashion with at least one predefinable gradient.

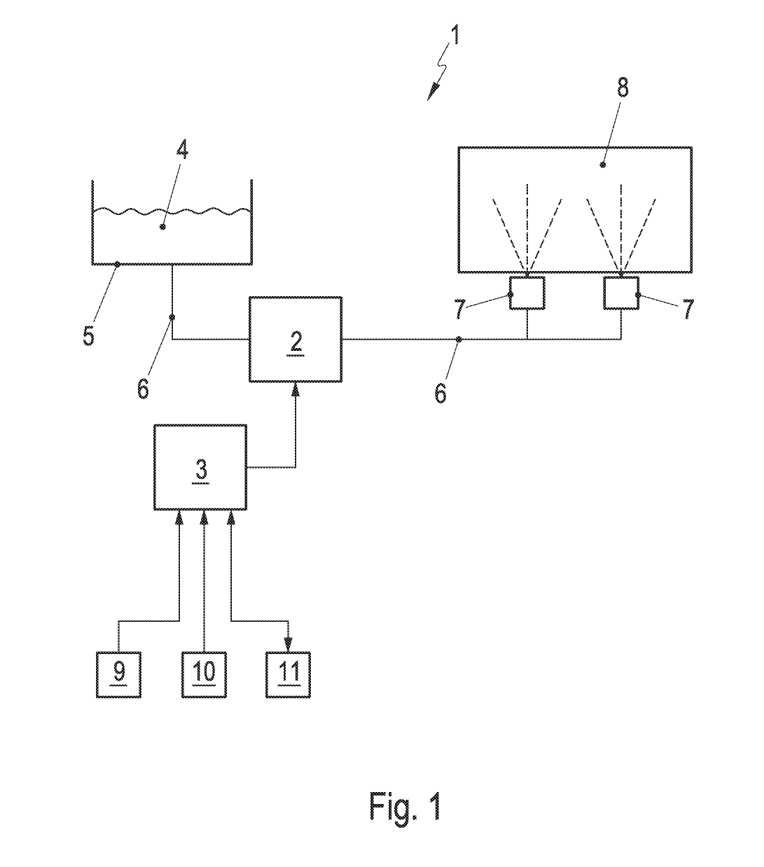

FIG. 1 shows a washing water pump device 1 having a washing water pump 2 and a control unit 3 which actuates the washing water pump 2 of the washing water pump device 1.

The washing water pump 2 feeds washing water 4 from a reservoir 5 via a line 6 to nozzles 7. The washing water is sprayed onto the windshield 8 from the nozzles 7, which windshield can be a front windshield or a rear windshield or the like. The control unit 3 controls the power of the washing water pump 2, wherein the power L can be actuated by means of pulse width modulation. In this context, the power L can be predefined as a PWM value.

The control unit 3 is connected in a signal or data conducting fashion to sensors 9, 10 and/or other control units 11 and receives signals relating to the vehicle velocity, the state of the roof and/or the outside temperature of the air outside the vehicle.

It is therefore possible, for example, to determine and transmit the state D of the roof by means of a sensor 9, the state of opening of a roof, sun roof or convertible top. In this context, the state of the roof can be specified as opened or closed. In this context, the status “opened” can already be set if the roof exceeds only a small threshold value during the opening process. Alternatively, the state “opened” can also be subdivided into intervals with the result that, for example, the roof can be indicated as being opened at least in 5%, 10% or 20% increments.

In this context, a correction value such as, for example, Offset_Dx for the value of the state of opening in the interval from x−1 to x can be assigned as a value.

It is also possible, for example, to determine and transmit the outside temperature by means of a sensor 10. Alternatively, the outside temperature can also be transmitted by a further control unit such as an engine control unit or an air conditioning control unit.

In this context, the outside temperature T can be specified in intervals or continuously. In this context, a correction value such as, for example, Offset_Tx for the value of the temperature in the interval from x−1 to x can be assigned as a value.

It is also possible to transmit the vehicle velocity v to the control unit 3 by means of a sensor or by a further control unit 11. In this context, the power L of the washing water pump 2 can be controlled as a function of the vehicle velocity v. It is therefore possible to actuate the power L differently as a PWM value of a pulse width modulation in increments for different velocity ranges.

In a first example, a first power value L=P1 for vehicle velocities is actuated in a first velocity range from 0 km/h to v1. A second power value P2 for the power is actuated for v=v1 to v2, and a further third power value P3 is actuated for v=v2 to v3.

If in this context a state of the roof is detected, a correction value for the state of the roof can be applied as: Offset_Dx for x, for example, as an element of an x-th interval. The following is therefore possible:
L=P1+Offset_D1 for v=0 to v1,
L=P2+Offset_D2 for v=v1 to v2,
L=P3+Offset_D3 for v=v2 to v3,
L=P4+Offset_D4 for v=v3 to v4,
L=P5+Offset_D5 for v=v4 to v5 and
L=P6+Offset_D6 for v=v5 to v6.

If in this context an outside temperature is detected, a correction value for the temperature can be applied as: Offset_Tx for x, for example, as an element of an x-th interval. The following is therefore possible:
L=P1+Offset_T1 for v=0 to v1,
L=P2+Offset_T2 for v=v1 to v2,
L=P3+Offset_T3 for v=v2 to v3,
L=P4+Offset_T4 for v=v3 to v4,
L=P5+Offset_T5 for v=v4 to v5 and
L=P6+Offset_T6 for v=v5 to v6.

It is particularly preferred if the temperature-dependent correction is carried out jointly with the correction as a function of the state of the roof. These corrections then bring about a change in the velocity-dependent value by means of a temperature-dependent contribution and a roof-dependent contribution.
L=P1+Offset_D1+Offset_T1 for v=0 to v1,
L=P2+Offset_D2+Offset_T2 for v=v1 to v2,
L=P3+Offset_D3+Offset_T3 for v=v2 to v3 etc.

As an alternative to the respective additive contribution, the correction can also be performed multiplicatively:
L=P1*Offset_D1*Offset_T1 for v=0 to v1,
L=P2*Offset_D2*Offset_T2 for v=v1 to v2,
L=P3*Offset_D3*Offset_T3 for v=v2 to v3 etc.

Alternatively, just one correction can also be performed additively and one correction multiplicatively.

According to one exemplary embodiment it is expedient if after the activation of the function and after the expiry of a predefined time period the pump power is controlled as a function of the vehicle velocity between 0% and 100%. For this purpose, the pump power can be actuated differently according to the above velocity windows. In this context, each velocity range is assigned an encoded PWM value for the power, which PWM value can be permanently predefined or can be selected in a parameterizable fashion.

If temperature values for the outside temperature are present, the PWM value for the power can be corrected in this respect. In this context, the correction is preferably carried out additively by means of an offset value, wherein the offset value can assume either positive or negative values. In this context, the offset value preferably assumes values between 100% and 100%. A corresponding procedure can be adopted when a value for the state of the roof is present. In this context, the value for the state of the roof can be treated additively as an offset value. The offset value for the state of the roof can also vary here between −100% and 100%. The sum of the influences is preferably limited here to values between 0% and 100% which are to be actuated.

In this context, the function of washing is carried out as a power output. This is equal in a first approximation to the velocity-dependent value L=Px+an Offset_Dx and, in the event of the outside temperature being below a threshold value, L=Px+Offset_Dx+Offset_Tx.

For L<=, L=0 is set, and for L>100, L=100 is set.

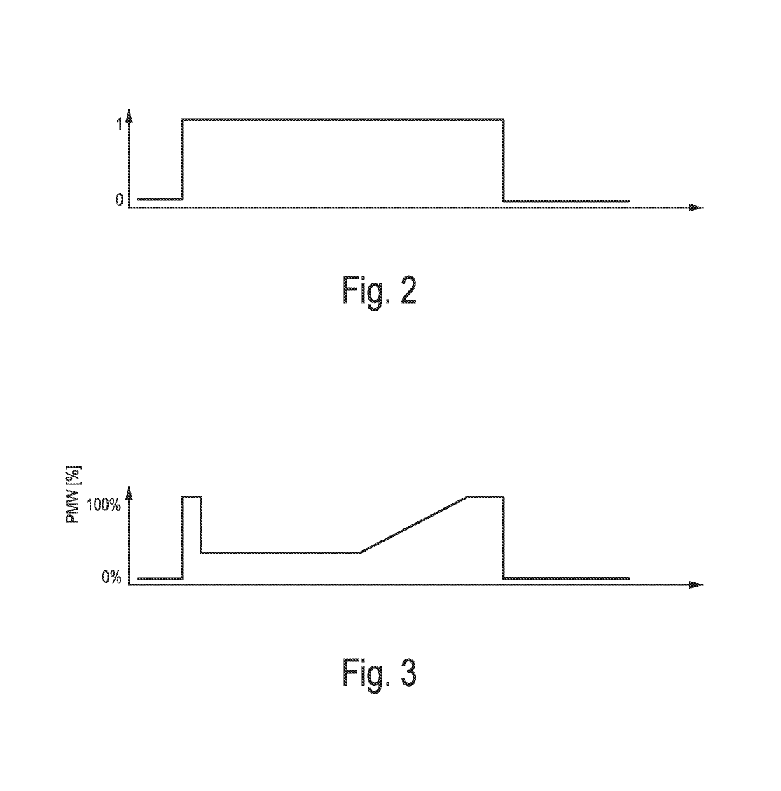

In the case of continuous activation of the washing function for longer than a predefined and, if appropriate, parameterizable time period, after the expiry of this time period the power is increased linearly to the maximum value of 100%. FIG. 2 shows here a diagram in which the activation state of the washing function is illustrated as a function of time. FIG. 3 shows the power L as a function of time. For t=t0 the washing function is started. The power L is set to the value L=100%. In the case of t=t1, the power is reduced to a value L1, wherein this value is retained up to t=t2. After expiry of the predefined time period at t=t2, the power L is raised from the value L1 to a value L2, wherein the value L2 is 100% in the example in FIG. 3. The value of L2 is reached here at t=t3, and the washing function is ended at t=t4.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

What is claimed is:

1. A washing water pump device comprising:
a washing water pump; and
a control unit configured to control operation of the washing water pump, the control unit being configured to receive and evaluate signals relating to a state of a vehicle and/or ambient conditions of the vehicle, the power (L) of the washing water pump being dynamically actuatable based on the received and evaluated signals.

2. The washing water pump device as recited in claim 1, wherein the power (L) of the washing water pump is actuatable by pulse width modulation (PWM).

3. The washing water pump device as recited in claim 1, wherein the power (L) of the washing water pump is actuatable as a function of the vehicle velocity (v), an outside temperature (T) and/or a state (D) of a roof of the vehicle by pulse width modulation (PWM).

4. The washing water pump device as recited in claim 1, wherein the power (L) of the washing water pump is actuatable as a function of the vehicle velocity (v) in pulse width modulation (PWM) increments or by a continuous PWM value.

5. The washing water pump device as recited in claim 4, wherein the velocity-dependent value of the PWM value is adjustable as a function of the outside temperature (T).

6. The washing water pump device as recited in claim 5, wherein the velocity-dependent value of the PWM value is adjustable additively and/or multiplicatively as a function of the outside temperature (T).

7. The washing water pump device as recited in claim 4, wherein the velocity-dependent value of the PWM value is adjustable as a function of a state (D) of a roof of the vehicle.

8. The washing water pump device as recited in claim 7, wherein the velocity-dependent value of the PWM value is adjustable additively and/or multiplicatively as a function of the state (D) of the roof

9. The washing water pump device as recited in claim 1, wherein the adjustment in the velocity-dependent value is additive and/or multiplicative by virtue of a temperature-dependent contribution and a roof-dependent contribution.

10. The washing water pump device as recited in claim 1, wherein the power (L) of the washing water pump is limited with a minimum value of 0% and a maximum value of 100%.

11. The washing water pump device as recited in claim 1, wherein in the case of an activation period t of the washing water pump which is longer than a predefinable time value, the power (L) of the washing water pump is actuatable in a rising fashion.

12. The washing water pump device as recited in claim 11, wherein the power (L) of the washing water pump is actuatable in a rising fashion with at least one predefinable gradient.

13. A method for controlling a washing water pump having a control unit for controlling the operation of the washing water pump, the method comprising:
receiving, by the control unit, signals relating to the state of a vehicle and/or ambient conditions of the vehicle; and
actuating the power (L) of the washing water pump dynamically based on the received signals.

14. The method as recited in claim 13, wherein the power (L) of the washing water pump is actuated by means of pulse width modulation (PWM).

15. The method as recited in claim 13, wherein the power of the washing water pump is controlled as a function of the vehicle velocity (v), the outside temperature (T) and/or a state (D) of a roof of the vehicle by pulse width modulation (PWM).

16. The method as recited in claim 13, wherein the power (L) of the washing water pump is actuated as a function of the vehicle velocity (v) in pulse width modulation (PWM) increments or by a continuous PWM value.

17. The method as recited in claim 16, wherein the velocity-dependent value of the PWM value is changed as a function of the outside temperature (T).

18. The method as recited in claim 17, wherein the velocity-dependent value of the PWM value is changed additively and/or multiplicatively as a function of the outside temperature (T).

19. The method as recited in claim 16, wherein the velocity-dependent value of the PWM value is changed as a function of a state (D) of a roof of the vehicle.

20. The method as recited in claim 19, wherein the velocity-dependent value of the PWM value is changed additively and/or multiplicatively as a function of the state (D) of the roof.

21. The method as recited in claim 13, wherein the change in the velocity- dependent value is additive and/or multiplicative by virtue of a temperature-dependent contribution and a roof-dependent contribution.

22. The method as recited in claim 13, wherein the power (L) of the washing water pump is limited with a minimum value of 0% and a maximum value of 100%.

23. The method as recited in claim 13, wherein in the case of an activation period t which is longer than a predefinable value the power of the washing water pump is actuated in a rising fashion.

24. The method as recited in claim 23, wherein the power (L) of the washing water pump is actuated in a rising fashion with at least one predefinable gradient.
